(19) United States
(12) Patent Application Publication
(10) Pub. No.: US 2025/0335240 A1
(43) Pub. Date: Oct. 30, 2025

(54) ADJUSTING BATCH AND/OR WORKLOAD SIZE FOR MODEL PROCESSING

(71) Applicant: Advanced Micro Devices, Inc., Santa Clara, CA (US)

(72) Inventor: Aditya Chatterjee, Bangalore (IN)

(73) Assignee: Advanced Micro Devices, Inc., Santa Clara, CA (US)

(21) Appl. No.: 18/651,343

(22) Filed: Apr. 30, 2024

(51) Int. Cl. G06F 9/48

(52) U.S. Cl. CPC G06F 9/4881

(57) ABSTRACT

A system is disclosed that has at least one input to receive at least one model and data to be processed with the at least one model, and at least one circuit configured to perform: in response to receiving, via the input, a first amount of data to be processed with the at least one model, based on configuration data indicating that when input data of the first amount is to be processed with the at least one model the input data should be supplemented with additional data to yield a second amount of data to be processed, generating additional data to supplement the first amount of data and yield aggregated data that has the second amount of data, the second amount of data being larger than the first amount of data, processing the aggregated data with the at least one model. Various other methods and systems are also disclosed.

### BACKGROUND

Neural networks or other machine learning models may be used to process data. The processing of the data may be done on computing hardware of various types, and various types of data may be processed. In some cases, multiple iterations of data processing may be performed with a model.

### BRIEF DESCRIPTION OF THE DRAWINGS

The accompanying drawings illustrate a number of exemplary implementations and are a part of the specification. Together with the following description, these drawings demonstrate and explain various principles of the present disclosure.

FIG. 1 is a block diagram of an exemplary computing system with which some implementations can operate.

FIGS. 2A and 2B are block diagrams illustrating exemplary workload and/or batch size adjustment schemes.

FIGS. 3 and 4 are flow diagrams illustrating different exemplary configuration processes for identifying a workload and/or batch size with which to process data using one or more models.

FIG. 5 is a flow diagram illustrating an exemplary process with which to process data with one or more models in different batch sides and/or adjusted workload sizes.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

Described herein are examples of techniques for identifying a workload and/or batch size with which to process data with one or more models being run in a computing environment.

In some cases, such a workload and/or batch size can be dependent on the model. For example, as an artifact of training or as a result of design, a model may run faster or slower with different batch sizes of data, where the batch size reflects an amount of data input to the model in a batch for processing by the model. When a model (e.g., a machine learning model) is received to be executed by a computing system, the model may be received without information as to with which batch size(s) the model may run faster than others. In addition, in some cases runtimes for batch sizes may be related to an environment in which a model is being processed, such as a software, firmware, and/or hardware platform with which the model is being used. As a result, even if some information regarding batch sizes with which a model may run quickly were known, that information may not be available for all computing environments or a particular computing environment in which the model is to be executed.

The inventor recognized and appreciated that this lack of information regarding a model with which to process data may raise a configuration question regarding the data to be processed. In some systems, the amount of data that may be received at any given time to be processed with a model may vary, such that at different times different amounts of data may be received for processing with the model. Without information regarding the model, it could be unclear whether to reduce processing time the amount of data received at a time should be processed in a single batch with the model or if the data should be divided into multiple smaller batches for processing. Processing the data with the model as multiple smaller batches could, for some models and in some environments, lead to a faster execution time than processing the data with the model in a single batch.

One possible solution could be to analyze the model and identify the data batch size that has the fastest runtime. With the fastest batch size, received data sets could be divided into multiple batches each having a speed matching that fastest batch size. However, the inventor has further recognized and appreciated that, due to the variation over time of an amount of data that can be received for processing with the model, it may be the case that an amount of data could be received at a time that, if processed as a single batch of that size or as some combination of smaller batch sizes, may run faster as multiple batch sizes than as a single batch. Accordingly, the inventor recognized the advantages of a system that could, for each size of multiple input workload sizes, identify whether a received input data workload of that size should be processed as a single batch or as some combination of smaller batches, so as to achieve a desired performance metric. Such a performance metric could be fastest or reduced runtime in some implementations, or could be other metrics in other implementations.

The inventor further recognized and appreciated, however, that while determining whether a received data workload should be processed with a model as a single batch or as multiple smaller batches may allow in some cases for achieving a performance metric, additional performance advantages may be achieved with other analyses of workload and/or batch size. In particular, the inventor recognized and appreciated that due to the lack of information regarding the batch size(s) with which a model may operate more quickly, or due to variation in computing environments (e.g., hardware and/or software with which a model may be processed) there could be multiple batch sizes with which the model could run quickly in a given computing environment. And it could be the case that, for a given received input workload size, there could be a larger workload (e.g., more data) with which the model may operate more quickly than with the received amount of data. This is counterintuitive, that processing more data may be faster than processing less data, but may arise in certain situations due to an intentional or inadvertent configuration of the model or due to a manner in which the model runs in a computer environment. The inventor recognized and appreciated that there may be situations in which expanding the amount of data to be processed, by supplementing the received data (e.g., by adding other data such as duplicative data, junk data, or any other data) may lead to a processing that may better achieve a desired performance metric (e.g., faster or reduced runtime).

Accordingly, described herein are examples of techniques for adjusting a workload and/or batch size for processing received data with one or more models. In some such techniques, when an input workload is received, the system may determine whether the input workload should be supplemented with additional data prior to be processed with a model. If so, additional data may be generated and both the received data and the supplemental data may be processed with the model. In some such cases, when the workload is increased with the additional data, the increased workload may be divided into multiple smaller batches for processing with the model. Also described herein are examples of techniques for evaluating a model in a computing system with different workload sizes to determine, for each workload size, whether received data of that workload size should be processed as a single batch, as a combination of smaller batches, or together with additional data as a larger workload size (which in turn might be processed with the model as a single batch or a combination of smaller batches).

Also described herein are techniques for evaluating different workload sizes and different batches sizes to determine workload and/or batch sizes with which to process different amounts of received data with a model in a computing environment. In some cases, the range of options for amounts of data that may be received for processing with a model may be large, and the options for each of those sizes for processing with a single batch or as a combination of multiple smaller batches, or as an increased size, may be larger still. As the number of options for workload sizes for received data increases, so do the number of options for processing such workloads. The amount of options to consider could increase in size exponentially, such that evaluating the options to identify recommended options for each workload size may take an impractical and unreasonable amount of time. For example, in many cases, considering each of the options could take in excess of one year for just one model and one set of options for workload sizes for data to be processed with the model. For a computing environment in which different models may be processed during a single work day or otherwise over a short period of time, or in other situations in which different models may be processed over time, a configuration period of over one year to determine recommended practices for each workload size for a model may be infeasible. Described herein are techniques that may reduce an analysis time during a configuration phase to minutes or a small number of hours (e.g., less than five hours, or less than three hours, or less than one hour) for these ranges of options for input amounts of data.

Some server systems can have multiple processor sockets with each processor socket having its own local memory to provide quicker access to data being processed in the same socket. That memory and data stored therein is accessible, though less quickly, to processes executing in a different socket of the system. Some such server systems may be referred to as “non-uniform memory access” (NUMA) systems. In some such NUMA systems, a combination of a processor socket and associated local memory can be referred to as a “NUMA node.”

In some cases, for different workload types to be processed on a NUMA system, a different number of NUMA Nodes Per Socket (NPS) may be used. For example, “NPS0” can be available on a two-socket system, which has one NUMA node per NUMA system. In such a system, memory can be interleaved across multiple (e.g., 16) memory channels in the NUMA system. In a “NPS1” system, by contrast, the whole CPU can be a single NUMA node having one socket with all the cores in the socket and all the associated memory in the one NUMA node. In some such NPS1 systems, memory can be interleaved across multiple (e.g., eight) memory channels, and PCIe devices on the socket can belong to this NUMA node.

In some systems, including some NUMA systems (e.g., an NPS1 system), when the system is to process an input dataset with a model the dataset can be divided into multiple batches each smaller than the input data set, which may then be separately processed by the model (e.g., sequentially). For example, one dataset can have a collection of 1024 images to be processed with a model built using machine learning, such as for classification or other purposes. Using some techniques described herein, a determination may be made of whether to run the entire collection through the NPS1 system all at once, split the collection of images into multiple batches to be run through the model separately (e.g., in serial or in parallel), or increase the number of images such that a larger number of images (larger than 1024) is processed with the model (either as a single batch or as multiple smaller batches). Below are described techniques by which to configure a system to be able to make this determination for a model as well as techniques for operating a system to determine how to process a workload with a model.

Before discussing examples of implementations in connection with the figures, a list of illustrative implementations is provided. While examples are provided, it should be appreciated that other implementations are possible.

In an implementation, a system has at least one input to receive at least one model and data to be processed with the at least one model, and at least one circuit configured to perform: in response to receiving, via the input, a first amount of data to be processed with the at least one model, based on configuration data indicating that when input data of the first amount is to be processed with the at least one model the input data should be supplemented with additional data to yield a second amount of data to be processed, generating additional data to supplement the first amount of data and yield aggregated data that has the second amount of data, the second amount of data being larger than the first amount of data, processing the aggregated data with the at least one model.

In another example, processing the aggregated data with the at least one model includes processing the aggregated data in a number of batches identified by the configuration data.

In another example, processing the aggregated data in the number of batches identified by the configuration data includes, based on the configuration data, dividing the aggregated data into the number of batches, the number of batches each including an amount of data identified by the configuration data.

In another example, dividing the aggregated data into the number of batches includes dividing the aggregated data into two batches, each batch having a different amount of data.

In another example, generating the additional data includes generating data with a predetermined pattern.

In another example, the at least one circuit is further configured to discard results of the processing corresponding to the additional data.

In another example, processing the aggregated data includes storing an identification of the additional data, and discarding results corresponding to the identification.

In another example, the configuration data is associated with the at least one model and with the at least one circuit with which the at least one model is to execute.

In another example, the configuration data indicates, for each amount of data of a plurality of amounts of data that may be received as input to be processed with the at least one model: a number of batches in which to process that amount of data with the at least one model, and/or a larger amount of data to process with the at least one model when that amount of data is received.

In another example, in a case that the configuration data indicates that, for an amount of data, a larger amount of data is to be processed, the configuration data further indicates a number of batches in which to process that larger amount of data.

In another example, the at least one circuit includes at least one execution circuit to execute instructions and at least one storage having encoded thereon executable instructions that, when executed by the at least one execution circuit, causes the at least one execution circuit to perform the generating based on the configuration data and the processing the aggregated data.

In another implementation, a system includes at least one circuit configured to perform: processing, with at least one model, a first input workload of a first size and a second input workload of a second size, the second size being larger than the first size; and in response to a runtime of the at least one model with the second input workload of the second size being less than a runtime of the at least one model with the first input workload of the first size, storing configuration data indicating that upon receipt of a subsequent workload of the first size to be processed by the at least one model, the subsequent workload is to be increased in size to the second size.

In an example, the at least one circuit is configured to run the at least one model with a first input workload of a first size at least in part by: processing, with the at least one model, a third workload of a third size in a single batch, processing, with the at least one model, the third input workload of the third size divided into at least two batches, and storing, in the configuration data, an indication of whether, upon receipt of a subsequent workload of the third size, it is faster to process the subsequent workload in the single batch or in the at least two batches.

In an example, processing, with the at least one model, the third input workload of the third size divided into at least two batches includes processing, with the at least one model, the third input workload of the third size with multiple different combinations of two batches, each different combination of two batches comprising different amounts of data in the two batches, and storing the indication in the configuration data includes storing an indication that the subsequent workload is to be processed as the combination of two batches having the fastest runtime.

In an example, processing, with the at least one model, the first input workload and the second input workload includes processing, with the at least one model, input workloads of a plurality of workload sizes between a workload size of 1 and a set workload size, wherein processing the input workloads of each size comprises processing each input workload as a single batch, the at least one circuit is further configured to perform: storing runtimes for the processing as a single batch of each input workload of the plurality of workload sizes, for each input workload of the plurality of workload sizes, storing configuration data indicating whether a workload of that size is run faster as a single batch or as a combination of smaller batches, and storing the configuration data indicating that the subsequent workload of the first size is to be increased to the second size comprises, for each input workload of the plurality of workload sizes, storing configuration data indicating whether a workload of that size is run faster as a workload of that size or as a workload of an indicated increased size.

In an example, the plurality of workload sizes includes each workload size between the workload size of 1 and the set workload size.

In an example, the at least one circuit is configured to perform the processing and storing in response to receipt of the at least one model to process data.

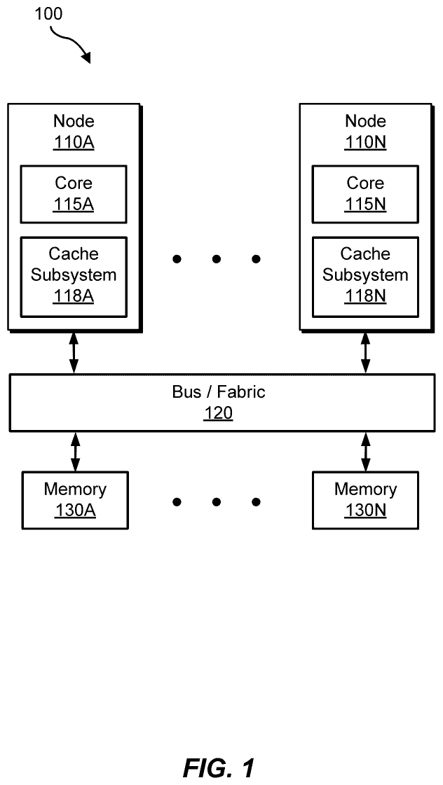

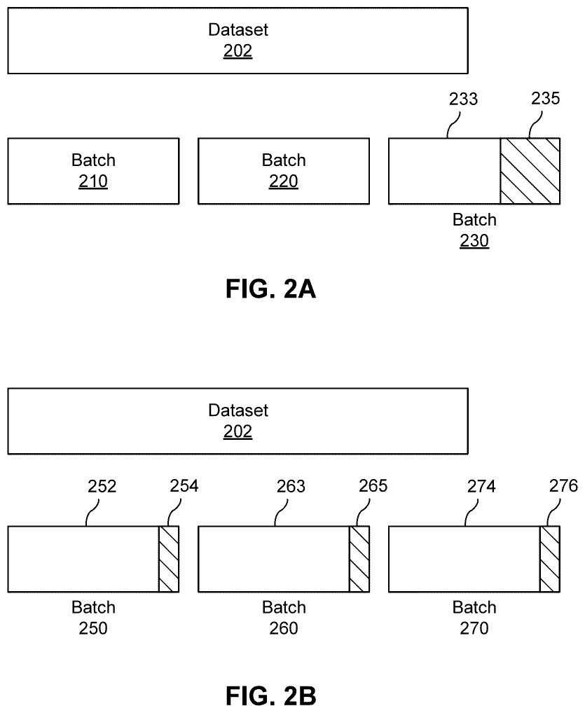

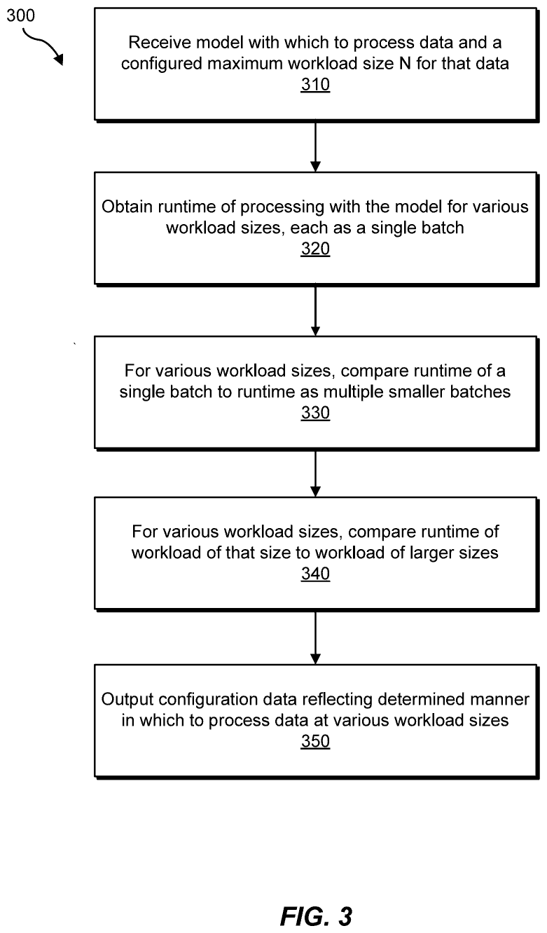

The following will provide, with reference to FIGS. 1 and 2, detailed descriptions of example systems for adjusting workload size. Detailed descriptions of corresponding computer-implemented methods will also be provided in connection with FIGS. 3-5. While illustrative implementations of the technology are described herein, including in connection with FIGS. 1-5, it should be appreciated that implementations are not limited to operating in accordance with any or all of these examples and that other implementations are possible.

FIG. 1 is a block diagram of an exemplary computing system 100, which in some cases can be a NUMA system but in other cases can be a different form of computing system. System 100 may be a device having any number of other components not shown, such as a rack-mounted server, a personal computer, a mobile device, a computer forming a part of a distributed data processing system (e.g., a cloud computing platform, a data center, or other distributed system), or other device. Implementations are not limited to operating with any particular form of device or environment in which the system 100 can be used. In the example of FIG. 1, system 100 includes one or more nodes 110A-N for performing one or more computing tasks, with the number of nodes per system potentially varying from implementation to implementation. Each node 110A-N can include a number (e.g., one or more) of cores 115A-N, respectively, with the number of cores potentially varying according to the implementation and, in some implementations, potentially varying from node to node. Each core 115A-N includes a number (e.g., one or more) of central processing units (CPUs) and associated components. Each node 110A-N also includes a corresponding cache subsystem 118A-N, respectively. Each cache subsystem 118A-N can include a number (e.g., one or more) of cache levels. Various types of caches are known, including in various types of hierarchies. Implementations are not limited to operating with any particular type(s) of or caches or cache hierarchical structures. In an implementation, cache subsystem 118A is locally accessible by core 115A as well as accessible by other nodes 110B (not shown)-110N through a bus/fabric 120, and each of the other cache subsystems 118B-110N is accessible by core 115A and each of the other cores 110C (not shown)-110N, and so on.

In one implementation, each node 110A-N is coupled to a corresponding memory 130A-N, respectively, through the bus/fabric 120. In an implementation, contents stored in memory 130A-N are first loaded to cache subsystem 118A-N for execution by core 115A-N. Each memory 130A-N can be accessible by others of node 110A-N.

As shown in FIG. 1, each core 115A-N is an exemplary execution circuit to execute instructions stored in memories 130A-N or other storage within each node 110A-N. The executable instructions can be encoded in the storage and executed by the execution circuit to perform various data processing. Such an execution circuit may include, for example, a central processing unit (CPU), graphics processing unit (GPU), accelerated processing unit (APU), tensor processing unit (TPU), data processing unit (DPU), field-programmable gate array (FPGA), other programmable logic, digital signal processor (DSP), or other hardware configured to perform operations designated by instructions, as implementations are not limited to operating with any particular hardware. The instructions may be software (e.g., system software, application software, or other software), firmware, hardware description language (e.g., VHDL, Verilog), or other instructions. Such instructions may include object code in various forms, intermediate code that may be executed on a framework or virtual machine, scripting language code, or other code, as implementations are not limited to any particular form of instructions.

In accordance with some techniques described herein, cores 115A-N may be configured to process received data using one or more models. Over time, the model(s) may change, such as in response to a user or other entity requesting a change in the model(s) to be used to process data. In some cases, each core 115A-N may process the same model, or in other cases different models may be processed on different cores 115A-N. When a model is received to be input, some techniques described herein may be used to configure the workload and/or batch sizes with which received data is processed using the model. In some cases, received data that is divided into batches per configuration data may be processed across different cores 115A-N, or in other cases the different batches of data created from received data may be processed on one of the cores 115A-N.

Many other devices or subsystems can be connected to system 100 in FIG. 1. Conversely, all of the components and devices illustrated in FIG. 1. System 100 can also employ any number of software, firmware, and/or hardware configurations. For example, one or more of the example implementations disclosed herein can be encoded as a computer program (also referred to as computer software, software applications, computer-readable instructions, and/or computer control logic) on a computer-readable medium.

The term “computer-readable medium,” as used herein, can generally refer to any form of device, carrier, or medium capable of storing or carrying computer-readable instructions. Examples of computer-readable media include, without limitation, non-transitory-type media, including storage media such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

FIGS. 2A and 2B are block diagrams illustrating exemplary workload and/or batch size adjustments. Under some such techniques, a dataset 202 of a certain size is to be processed with a model, which may be running on a NPS1 computing hardware or other hardware. (While, for ease of description, examples are described herein in connection with a NUMA and NPS1 hardware, it should be appreciated that implementations are not limited to operating with this illustrative hardware and that other hardware can be used in other implementations.) In some implementations, the model can be a Deep Learning model, such as a Deep Neural Network (DNN). In other implementations, the model can be a Convolutional Neural Network (CNN), but it should be appreciated that in other implementations any of a variety of other models resulting from use of machine learning can be used. Implementations are not limited to operating with any particular form of model.

In connection with some techniques described herein, prior to the start of the example of FIGS. 2A and 2B, a previously-performed configuration process could have yielded configuration data indicating, for each of a variety of workload sizes, whether input data of each workload size should be processed as a single batch, as multiple smaller batches, and/or together with additional data as a larger workload size (which, in some cases, might be processed as a single batch or as a combination of multiple smaller batches). The configuration data may indicate this workload and/or batch size so as to achieve, as a result of testing of the model in the computing system during a prior configuration phase, the workload and/or batch sizes that can yield a desired performance metric. Such a desired performance metric may be shortest execution time for processing of received dataset 202 with the model. As discussed above, due to intentional or inadvertent configuration of the model during creation of the model, and/or due to a manner in which the model runs in or with the hardware and/or software of a computer system, it may be faster to process received data of a certain workload as a larger workload (i.e., with more data than was received) and/or as a combination of smaller batches, than it would be to process the received data with the model as a single batch. Thus, the configuration data may indicate how the received dataset 202, of a workload size that is the amount of data to be processed with the model, is to be processed with the model: as only the received data or with supplemental data, and/or as a single batch or as a combination of smaller batches.

In the example of FIGS. 2A and 2B, the computer system has reviewed the configuration data and determined that, for the received amount of data of dataset 202 (i.e., the workload size of dataset 202), dataset 202 is to be expanded with supplemental data and then divided into multiple smaller batches each of a size identified by the configuration data. In this example, the size of each of the multiple smaller batches is identified by the configuration data.

Referring to FIG. 2A, the configuration data indicates that dataset 202 is to be expanded from the input workload size to a larger workload size—larger by an amount of data 235—and then divided into three batches 210, 220 and 230, each of a size identified by the configuration data. The size of the batches can be consistent in some implementations, or for some workload sizes in some implementations, or can in other implementations or for other workloads vary between the batches such that the multiple batches are of different sizes. As shown in FIG. 2A, batches 210 and 220 are filled with data from dataset 202. Batch 230 is an aggregate of the received data and additional data, and thus is shown with a part 233 and an expansion 235. Part 233 is filled with data from dataset 202 and expansion 235 is filled with additional data. The additional data can be generated by the system for processing. Implementations are not limited to operating with any particular additional data. In some cases, the additional data may be blank data, such as data that is all of one value (e.g., all 0s or all 1s). As another example, the additional data may be a duplicate of some of the dataset 202 (e.g., of some of the part 233). As a further example, the additional data may be junk data that exists in memory at the time the memory is allocated, or other junk data. Implementations are not limited to operating with any particular form of additional data.

Accordingly, dataset 202 is divided into 3 batches 210, 220 and 230, to be processed. In some implementations, the batches may be run sequentially, though implementations are not limited to any particular manner of processing the three batches.

FIG. 2B illustrates another example implementation, consistent with FIG. 2A in that configuration data indicates that the received workload dataset 202 is to be expanded in size to yield a larger workload, and that this larger workload is to be divided into three batches for processing with a model. In this example, dataset 202 is divided into three batches 250, 260 and 270, each partially filled with data from dataset 202 and expanded to reach a desired batch size. As previously discussed in connection with FIG. 2A, the sizes of the batches may be consistent or may vary between the batches. In this example, each of the batches 250, 260, 270 includes some of the data from received workload 202 as well as supplemental data to yield the expanded workload size indicated by the configuration data of this example. As shown in FIG. 2B, batch 250 includes a part 252 filled with data from dataset 202 and supplemental data 254; batch 260 includes a part 263 filled with data from dataset 202 and supplemental data 265; and batch 270 includes a part 274 filled with data from dataset 202 and supplemental data 276. In this example implementation, supplemental data 254, 265 and 276 can be of the same or varying size and can add up to the size of the supplemental data 235 of FIG. 2A.

In some implementations, batches 210-230 shown in FIG. 2A are loaded into a cache subsystem from a main memory to be sequentially run by an associated core on a NPS1 model. Similarly, batches 250-270 are also loaded into a cache subsystem from a main memory to be sequentially run by an associated core on a NPS1 model. In other implementations, dataset 202 is loaded into a cache subsystem from a main memory, an associated core arranges dataset 202 into either batches 210-230 or batches 250-270, which are then sequentially run by the core on a NPS1 model.

It should be appreciated that different implementations may operate with different data, and with different models. Some data may include images, for models that process images. Other data may be text, for models that operate on text. Other data may be of other types, for models that operate with other types of data. In some implementations, such as those that operate with multi-modal models that operate on multiple types of data, the data may be of varying types (e.g., text and images). Accordingly, in the example of FIGS. 2A and 2B, the dataset 202 may be any suitable type(s) of data, as implementations are not limited in this respect.

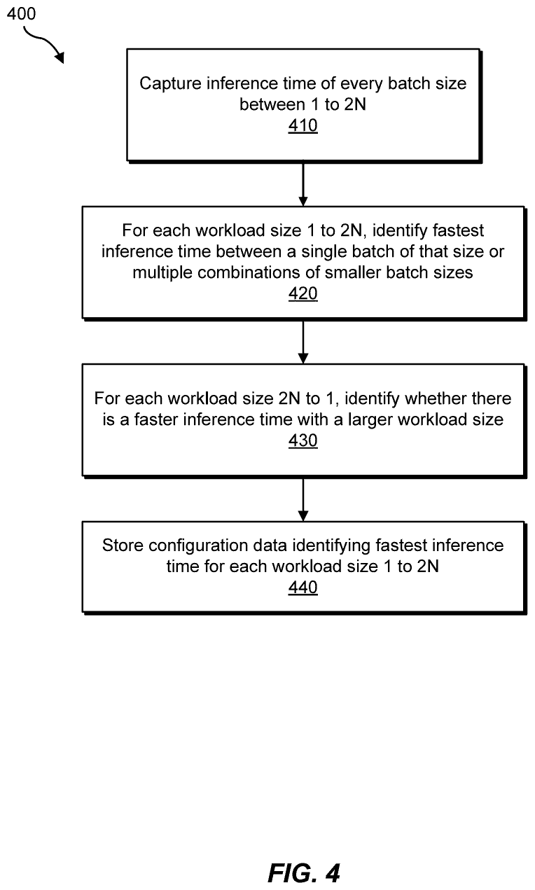

FIGS. 3 and 4 are flow diagrams illustrating exemplary configuration processes 300 and 400 for identifying a workload and/or batch size with which to process different amounts of received data with a model. In some implementations, there may be a number of possibilities for processing received data with a model, including as a single batch, as a combination of smaller batches, and/or with an increased workload size by supplementing the received data with additional data. The processes 300, 400 may be implemented in hardware and/or software, such as in circuits or in instructions executable by circuits (e.g., processors or other circuits) to perform the described operations.

Referring to FIG. 3, configuration process 300 begins in block 310 with receiving a model with which to process received data. Receipt of the model, which may be a change from a prior model that was executing, may in some implementations trigger the process 300. While for ease of description, an example of a single model is provided, it should be appreciated that some implementations may operate with multiple models, such as an ensemble of models that are to operate in parallel and/or in serial to process received data. The configuration process of FIG. 3 may be performed to identify, for processing of data with this model in the computing environment in which the model Is to be processed (e.g., the hardware and/or software of the environment in which the model will be processed), what workload and/or batch sizes to use for processing received data, where the data is received for processing in a variety of workload sizes. In block 310, a configured maximum workload size N may also be received. The configured maximum workload size N may be received as user input, or otherwise set as a configuration value. The maximum workload size may not be a strict limit on workload, but instead may reflect a prediction on an amount of data that may be received at one time for processing with the model. The configured maximum workload size N may be used as described below to identify workload and/or batch sizes with which to process data, such as by limiting the size(s) considered during the configuration process.

In block 320, the configuration process 300 obtains a runtime for processing the model, in the computing environment, with varying workload sizes, each as a single batch. The varying workload sizes may include each workload size between two values, such that the runtime is obtained for every possible integer workload size between two numbers. The two numbers can, in some cases, be 1 and 2N. 2N is twice the received maximum workload size N. Obtaining runtimes for processing data with the model in this way may aid in cases in which the configured maximum was too conservative or otherwise too low, and could aid in evaluating options for increasing workload size in accordance with some techniques described herein. In some implementations, the runtime is obtained by processing data with the model, where the data is any suitable data (e.g., junk data, data of all one value, blank data, or other data). Accordingly, in some implementations, the model(s) are used to process a workload of data size 1 in a single batch of data size 1, then to process a workload of data size 2 in a single batch of data size 2, then to process a workload of data size 3 in a single batch of data size 3, and so on for every integer up to 2N. The runtimes for the model may thus be stored for each workload size.

In block 320, the configuration process 300 thus obtains runtime data for each of multiple workload and batch sizes, such as for all values from 1 to 2N. This is for processing different workload sizes in a single batch of that size. In subsequent parts of configuration process 300, the process 300 determines whether for particular workload sizes it may be faster to process the data with the model in other ways.

In block 330, the configuration process 300 proceeds to determining whether, rather than processing the workload in a single batch, it may be faster to process the workload in multiple (e.g., two or more) smaller batches. To do so, the configuration process 300 may for a particular workload size obtain (from the data of block 320) the runtime for a single batch of that workload size and the runtimes for one or more different combinations of smaller batches having a total amount of data (across those batches) equal to the workload size being considered. This process may be repeated for each of multiple workload sizes, such as for all workload sizes for which runtime data was obtained in block 320. In some such implementations, the configuration process 300 may start at size 1 and iteratively consider each workload size, increasing by one additional data unit in each iteration. In each iteration, the configuration process 300 may store configuration data indicating, for a workload size, whether the fastest runtime is with a single batch or with multiple batches and, in the case of multiple batches, what particular combination of smaller batches is the fastest. In each iteration, the process 300 may use runtime data obtained in block 320 for a runtime of a single batch or runtimes of each batch when evaluating a combination of smaller batches. In addition, in some such implementations, later iterations may use the fastest runtime data determined for earlier iterations. For example, if for an iteration for workload size 8, the process 300 is considering a combination of smaller batches each of size 4, the configuration process 300 may in that iteration leverage a prior determination that the fastest way to process four data units is to process it as two batches each of size 2.

While an example has been described, and will continue to be described, where a desired performance metric is fastest runtime, other implementations that use other performance metrics are possible. In such other implementations, other performance data may be collected in block 320 and used in block 330 and the other blocks discussed below.

As a result of block 330, the configuration process has available to it configuration data indicating, for each of various workload sizes, whether to process received data of a given workload size as a single batch or as multiple smaller batches (and in that case, what smaller batches) so as to achieve a desired performance metric such as shortest runtime. This information could be used at runtime to determine how to process received data of a given workload size, as a single batch or in multiple smaller batches, by looking up in the configuration data the corresponding configuration data for that workload size.

As discussed above, the inventors have appreciated that it may be the case that for some workload sizes, it may be faster to process data with the model not only with the received data, but with additional data. To determine whether to supplement received data with additional data to yield a larger workload size so as to achieve a desired performance metric (e.g., shortest runtime), some implementations may proceed to block 340 in which larger workload sizes are evaluated.

In block 340, the configuration process 300 evaluates, for each of various workload sizes, whether the runtime data from blocks 320, 330 indicates that any larger workload size has a shorter runtime than a workload size being considered. In block 340, the varying workload sizes may, in some implementations, include each workload size for which data was obtained in block 320 and that was considered in block 330. In some such implementations, the configuration process 300 may start at size 2N (twice the configured maximum workload size N from block 310) and iteratively consider each workload size, decreasing by one additional data unit in each iteration. In each iteration, the configuration process 300 may evaluate whether any workload size larger than the workload size under evaluation has a shorter runtime (or otherwise meets a desired performance metric). The configuration process 300 may then store configuration data indicating, for a workload size, whether the fastest runtime is with that workload size or with a larger workload size. The configuration data in each iteration may also indicate, using the results of block 330 or earlier iterations of block 340, whether the fastest runtime for that workload size is as a single batch of data of that workload size or as a combination of batches having a total data size matching that workload size.

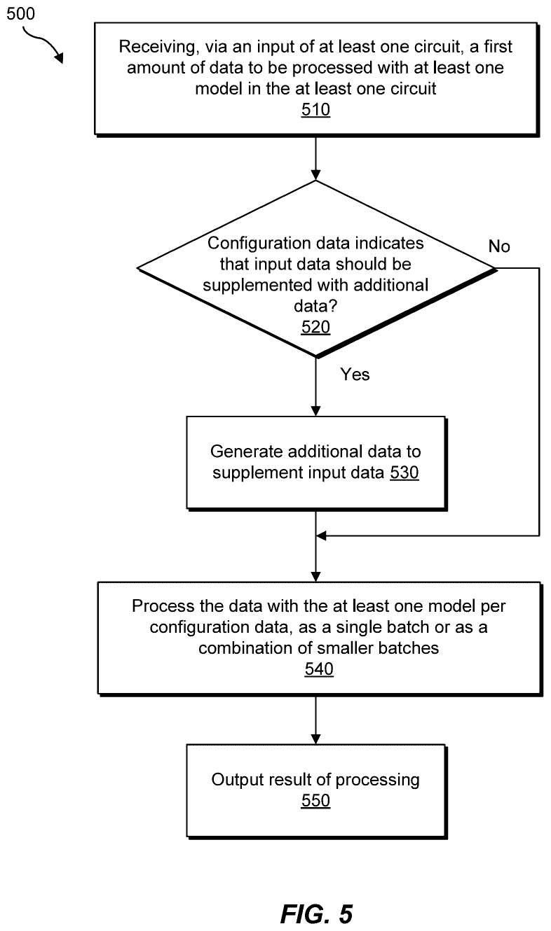

As a result of block 340, the configuration process has configuration data indicating, for each of multiple workload sizes (e.g., every integer size from 1 to 2N) whether data of that workload size should be processed as a single batch of that workload size, as multiple smaller batches totaling that workload size, or as a larger workload size (and, in turn, whether that larger workload size should be processed as a single batch or as multiple smaller batches totaling that larger workload size). In block 350, the configuration process 300 outputs the configuration data, such as for use in a process like the illustrative process of FIG. 5.

FIG. 4 illustrates an example of a particular way in which configuration data may be obtained in some implementations. The configuration process of FIG. 4 may have a fast processing time, which may be advantageous in some cases. In some implementations, the process of FIG. 4 may be one manner in which to implement the process of FIG. 3. It should be appreciated that implementations are not limited to operating in accordance with the examples of FIGS. 3-4.

In the example of FIG. 4, the runtime for a model that is evaluating may be an inference time to perform an inference operation with received data. Prior to the start of process 400, a model may be received as well as a configured maximum workload size N, per the discussion in connection with FIG. 3 above. In block 410, the configuration process 400 begins with capturing inference time of every workload size. The inference time can be obtained by processing configuration data with the model across multiple iterations, where each iteration has a different workload size. In some cases, the multiple workloads may correspond to workloads of sizes matching each integer between 1 and 2N (double the maximum configured workload size N). In each iteration, the data may be processed with the model to perform an inference operation and the inference time recorded.

In block 420, the configuration process 400 loops over workload sizes from 1 to 2N, for each workload size determining whether inference time for a single batch of that workload size is less than a combined inference time for multiple batches of a size totaling the workload size.

For example, for a given workload size M, where M is an integer between 1 and N, configuration process 300 loops through different combinations of smaller batch sizes for processing that workload size M, as two or more batches of data that collectively are an amount of data matching the workload size. For example, for each number K between 1 and M, configuration process 400 may divides and/or expands the dataset into two batches of sizes, one of size K and one of size M−K. The configuration process 400 may then determine whether the inference time (from block 410) for a single batch of size M is less than a combined inference time for a batch of size K and a batch of size M−K. The inference times for the batches of size K and M−K may be from the inference times of block 410 or from earlier iterations (e.g., lower values of M) of block 420.

In a given iteration for workload size M, K can be evaluated for values from 1 to M−1 to identify the fastest inference time, either the inference time of a single batch of size M or some value K for a combination of batch sizes K and M−K. Once K reaches M−1, the configuration process 400 may end the iteration for size M, store configuration data indicating the batch size(s) that yielded the fastest runtime, and move to the next iteration for the next M by incrementing M.

In one specific implementation of configuration process 400, a data structure (e.g., vector, array, or other storage) RUN may be defined, such that for a workload size B, RUN[B] is the inference time collected in block 410 of FIG. 4. In block 420, a second data structure (e.g., vector, array, etc.) OPT1 is created, where OPT1[B] for a workload size B is the smallest runtime between running the workload as a single batch or as a combination of smaller batches.

First, OPT1[1] is initialized to be the same as RUN[1]. This is because, for a workload size of 1, the workload cannot be split into smaller components.

To compute other values of OPT1[ ], a bottom to top approach is followed for each workload size from 1 to 2N, iteratively moving from calculating OPT1[B] to OPT1[B+1] to OPT1[B+2] and so on. For each workload size value B from 1 to 2N, within the iteration for size B any potential reduced inference time from processing the workload as a combination of smaller workloads is found using a top to bottom approach for that iteration.

In the bottom to top approach within an iteration for computing OPT1[B], as OPT1[ ] for all dataset size<B was already computed in earlier iterations of the bottom to top approach for B=1 . . . 2N, the configuration process can leverage that data to find the fastest way to process smaller batches, either as a single batch of that size or as even further smaller batches. For example, when determining whether it would be faster to execute a batch size B as a combination of smaller batches, RUN[B] can be compared to varying values of M for a batch of size M (where M<B) and another batch of size B−M. For each M, because M<B, OPT1[M] and OPT1[B−M] can be obtained from prior iterations. OPT1[M] will indicate the fastest runtime for OPT1[M], either as a single batch or as a combination of smaller batches, as will OPT1[B−M]. By comparing RUN[B] to OPT1[M]+OPT1[B−M] for each value of M from B−1 down to B/2. It is noted that for OPT1[M]+OPT1[B−M], M ranging from (B/2)−1 to 1 overlaps M ranging from B−1 to B/2. For example, when M=B−2, OPT1[M]+OPT1[B−M]=OPT1[B−2]+OPT1[2]; and when M=2, OPT1[M]+OPT1[B−M]=OPT1[2]+OPT1[B−2]. Therefore, the M's range from (B/2)−1 to 1 can in some implementations be skipped in this process. In other implementations, the analysis may be performed for all values of M from B−1 down to 1. Once the top to bottom traversal for M is complete for an iteration of B, the smallest value of RUN[B] or OPT1[M]+OPT1[B−M] is stored as OPT1[B] before moving on to the next workload size B+1.

This technique can use a dynamic programming approach with two levels of traversal: top to bottom traversal for values M within a bottom to top traversal for values B. For each dataset size B, the time complexity to compute OPT1[B] will be O(B). So, to compute all values of OPT1 till N, the time complexity could be O(N²).

In this technique, the splitting batch into smaller batches can be summarized in some implementations as the following.
Input: Maximum workload size 2N for maximum dataset size N, RUN[ ].
Output: OPT1[ ].
Steps:
1. Initialize OPT1[1] to RUN[1].
2. For each batch size 2 to N:
   a. Current batch size is B.
   b. Find the minimum value of (OPT1[M]+OPT1[B−M]) or RUN(B), for each batch size M from B−1 to B/2 (or 1)
   c. Set OPT1[B] to the minimum value from Step 2b

For increasing workload size, one might assume increasing the workload size will increase the execution time, but this is not the case with Deep Learning models or other machine learning models, or other models. As peak performance may be achieved at specific workload sizes, increasing the workload size is a potential inference time reduction technique. For this purpose, in block 430 of FIG. 4, for each workload size 2N to 1, process 400 identifies whether there is a faster inference time with a larger workload size. A data structure OPT2[ ] is created, where OPT2[B] indicates a lowest time to run a dataset of workload size B by either splitting the workload into multiple smaller batches or by increasing the workload size (and, in some cases, then splitting the larger workload into multiple smaller batches). In block 440 of FIG. 4, configuration data identifying fastest inference time for each workload size 1 to 2N is stored and can be used in the future for optimizing runtime. For example, when a user needs to run a deep learning model with a workload of size X, where X is between 1 and N, the system of the present disclosure retrieves the stored size X configuration data, and may expand and split the workload according to the configuration data.

If a highest workload size is to be 2N (N is the maximum dataset size), OPT2[2N] is first assigned to be equal to OPT1[2N], and the approach (single batch or multiple smaller batches) stored as equal to the instruction for OPT1[2N] that achieves that lowest runtime. This is because, since 2N is the largest workload to be considered in this process, there is no option to increase the workload to a value beyond 2N. Thus, OPT2[2N] can equal the shortest known execution time, OPT1[2N].

In some implementations, the highest workload size can be a value other than 2N (larger than N though). A proper value aids in identifying an improved runtime with for each workload size. This value may depend on which machine learning model is used. In the examples described herein, 2N is chosen for the value for illustrative deep learning workloads.

To compute other values of OPT2[ ], a top to bottom approach is followed from 2N down to 1. Accordingly, computing is started from OPT2[2N−1] and goes down one by one in each iteration to OPT2[1]. For each value B, a bottom to top approach is practiced in the iteration for calculating OPT2[B]. In particular, for computing OPT2[B], since the batch size can be increased, a value M is increased across multiple iterations from B to 2N to identify, for each larger workload size, whether OPT2[K]<OPT1[B]. The smallest runtime is found between OPT1[B] and OPT2[ ] from OPT2[M=B+1] through OPT2[M=2N], then the value for OPT2[B] is set based on that value and instructions are stored corresponding to how that amount of data is to be processed (e.g., as a single batch of that size or as a combination of smaller batches). In this example, OPT1[ ] is evaluated instead of RUN[ ], to enable any such larger workload size to be split into multiple components to extract best performance. This results in, for any B, OPT2[B]=MINIMUM(OPT1[M]), where B<=M<=2N, for this example.

In other implementations, for a given B, the runtime can be adjusted for a given workload based on the workload properties. M can go from B to a value lower than 2N. For example, M goes from B to 2B or from B to a minimum(2×B², 2N). However, extending the range to 2N may aid in ensuring correct results for more kinds of workloads.
An algorithm for increasing workload size can be the following. For inputs: maximum workload size is 2N; RUN[ ] and OPT1[ ]. For output: OPT2[ ], following steps are taken.
1. Initialize the base case: OPT2[2N]=OPT1[2N].
2. For each batch size from 2N−1 to 1:
   a. Current batch size is B.
   b. Find minimum value of OPT1[K] where K>=B and K<=2N.
   c. Set the minimum value for that OPT2[B] to that minimum value.

Configuration processes 300, 400 explained illustrative ways of assembling configuration data indicating, for each of various workload sizes, a manner in which to process the workload so as to achieve a desired performance metric, such as shortest time to process that data with a model in a given computing environment.

That configuration data can be used in various ways to process data at runtime. An example is provided in connection with FIG. 5.

FIG. 5 is a flow diagram illustrating an exemplary process 500 for processing data with at least one model, with at least one circuit, with adjusted batch and/or workload size.

Process 500 begins with receiving, in block 510, via an input of the circuit(s), a first amount of data to be processed with the model(s) and the circuit(s). In one implementation, the circuit(s) includes a computing system 100, and the data may be inputted from memories 130A-N into cache subsystems 118A-N for being subsequently executed by core 115A-N, as shown in FIG. 1.

In block 520, the circuit(s) determine whether configuration data for the model(s) and/or for the circuit(s) indicates, for an amount of received data, whether additional data should be generated to be processed together with the received data as aggregated data. The configuration data may indicate, for the received amount of data, whether a larger workload size should be used, which may indicate that additional data is to be generated.

If so, in block 530 the circuit(s) generate additional data. This may be done in a variety of ways, as implementations are not limited in this respect. For example, data that is all one value (e.g., all logic 1s or logic 0s) may be generated, in an amount of units of data that matches the indication in the configuration data. The form of generated data may vary based on the use case, and may correspond to the type of data received as input. For example, if images are received as input, additional data that is formatted as images may be received.

In block 540, the data to be processed (either the received data, or the received data as supplemented with additional data) is processed by the circuit(s) with the model(s). Per the configuration data, in either case, the data may be processed in a single batch or as a combination of smaller batches. The data is processed by the circuit(s) with the model(s) and, in block 550, the result of the processing is output. It should be appreciated that, as implementations are not limited to a particular form of model or input, implementations are not limited to a particular form of output.

In a case that additional data was generated in block 530 for processing in block 540, that data may not be relevant to the data received in block 510 and thus the output corresponding to that additional data may not be relevant to an entity from which the data was received in block 510. For example, if the model(s) are processing the data to do classification, object recognition, or other inference on each unit of data (e.g., each image) in the data, the classification, object recognition, or other inference output for the additional data may not be relevant. Accordingly, in block 550, in addition to outputting the result of the processing for the data received in block 510, the circuit(s) may discard any result(s) corresponding to the additional data. This may be done in a variety of ways, as embodiments are not limited in this respect. For example, an identification of the additional data that was generated may be stored, and results corresponding to data identified by the identification may be discarded.

Described herein are some techniques for assembling configuration process for a computing system running models (e.g., machine learning models) to identify a workload size and/or batch sizes that may achieve a desired performance metric for various workload sizes. The may include expanding a received input dataset with supplemental data prior to processing and/or splitting data into to multiple batches for processing. Also described herein are some techniques for processing data with model(s) using such configuration data, in an amount of data matching the received amount of data or as a larger amount of data, and as a single batch of data or multiple smaller batches of data.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of example system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

In various implementations, all or a portion of example system 100 in FIG. 1 can facilitate multi-tenancy within a cloud-based computing environment. In other words, the modules described herein can configure a computing system (e.g., a server) to facilitate multi-tenancy for one or more of the functions described herein. For example, one or more of the modules described herein can program a server to enable two or more clients (e.g., customers) to share an application that is running on the server. A server programmed in this manner can share an application, operating system, processing system, and/or storage system among multiple customers (i.e., tenants). One or more of the modules described herein can also partition data and/or configuration information of a multi-tenant application for each customer such that one customer cannot access data and/or configuration information of another customer.

According to various implementations, all or a portion of example system 100 in FIG. 1 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of example system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus comprising:
at least one input to receive at least one model and data to be processed with the at least one model; and
at least one circuit configured to perform:
in response to receiving, via the at least one input, a first amount of data to be processed with the at least one model,
based on configuration data indicating that when input data of the first amount is to be processed with the at least one model the input data should be supplemented with additional data to yield a second amount of data to be processed, generating additional data to supplement the first amount of data and yield aggregated data that has the second amount of data, the second amount of data being larger than the first amount of data; and
processing the aggregated data with the at least one model, the aggregated data comprising the first amount of data and the additional data.

2. The apparatus of claim 1, wherein processing the aggregated data with the at least one model comprises processing the aggregated data in a number of batches identified by the configuration data.

3. The apparatus of claim 2, wherein processing the aggregated data in the number of batches identified by the configuration data comprises, based on the configuration data, dividing the aggregated data into the number of batches, the number of batches each comprising an amount of data identified by the configuration data.

4. The apparatus of claim 3, wherein dividing the aggregated data into the number of batches comprises dividing the aggregated data into two batches, each batch having a different amount of data.

5. The apparatus of claim 1, wherein generating the additional data comprises generating data matching a pattern.

6. The apparatus of claim 1, wherein the at least one circuit is further configured to discard results of the processing corresponding to the additional data.

7. The apparatus of claim 6, wherein processing the aggregated data comprises:
storing an identification of the additional data; and
discarding results corresponding to the identification.

8. The apparatus of claim 1, wherein the configuration data is associated with the at least one model and with the at least one circuit with which the at least one model is to execute.

9. The apparatus of claim 1, wherein the configuration data indicates, for each amount of data of a plurality of amounts of data that may be received as input to be processed with the at least one model:
a number of batches in which to process that amount of data with the at least one model, and/or
a larger amount of data to process with the at least one model when that amount of data is received.

10. The apparatus of claim 9, wherein in a case that the configuration data indicates that, for an amount of data, a larger amount of data is to be processed, the configuration data further indicates a number of batches in which to process that larger amount of data.

11. The apparatus of claim 10, wherein the at least one circuit comprises at least one execution circuit to execute instructions and at least one storage having encoded thereon executable instructions that, when executed by the at least one execution circuit, causes the at least one execution circuit to perform the generating based on the configuration data and the processing the aggregated data.

12. A method comprising:
receiving, via an input of at least one circuit, a first amount of data to be processed with at least one model in the at least one circuit;
generating additional data based on configuration data indicating that when input data of the first amount is to be processed with the at least one model, the input data should be supplemented with additional data to yield a second amount of data to be processed;
supplementing the first amount of data with the additional data to yield aggregated data that has the second amount of data, the second amount of data being larger than the first amount of data; and
processing the aggregated data with the at least one model, the aggregated data comprising the first amount of data and the additional data.

13. The method of claim 12 further comprising processing, with the at least one model, the aggregated data in a number of batches identified by the configuration data.

14. The method of claim 12 further comprising:
storing an identification of the additional data; and
discarding results corresponding to the identification.

15. An apparatus comprising:
at least one input to receive at least one model and data to be processed with the at least one model; and
at least one circuit configured to perform:
processing, with at least one model, a first input workload of a first size and a second input workload of a second size, the second size being larger than the first size; and
in response to a runtime of the at least one model with the second input workload of the second size being less than a runtime of the at least one model with the first input workload of the first size, storing configuration data indicating that upon receipt of a subsequent workload of the first size to be processed by the at least one model, the subsequent workload is to be increased in size to the second size.

16. The apparatus of claim 15, wherein the at least one circuit is configured to run the at least one model with a first input workload of a first size at least in part by:
processing, with the at least one model, a third workload of a third size in a single batch;
processing, with the at least one model, the third workload of the third size divided into at least two batches; and
storing, in the configuration data, an indication of whether, upon receipt of a subsequent workload of the third size, it is faster to process the subsequent workload in the single batch or in the at least two batches.

17. The apparatus of claim 16, wherein:
processing, with the at least one model, the third workload of the third size divided into at least two batches comprises processing, with the at least one model, the third workload of the third size with multiple different combinations of two batches, each different combination of two batches comprising different amounts of data in the two batches; and
storing the indication in the configuration data comprises storing an indication that the subsequent workload is to be processed as a combination of two batches having a fastest runtime.

18. The apparatus of claim 15, wherein:
processing, with the at least one model, the first input workload and the second input workload comprises processing, with the at least one model, input workloads of a plurality of workload sizes between a workload size of 1 and a set workload size, wherein processing the input workloads of each size comprises processing each input workload as a single batch;
the at least one circuit is further configured to perform:
storing runtimes for the processing as a single batch of each input workload of the plurality of workload sizes; and
for each input workload of the plurality of workload sizes, storing configuration data indicating whether a workload of that size is run faster as a single batch or as a combination of smaller batches; and
storing the configuration data indicating that the subsequent workload of the first size is to be increased to the second size comprises, for each input workload of the plurality of workload sizes, storing configuration data indicating whether a workload of that size is run faster as a workload of that size or as a workload of an indicated increased size.

19. The apparatus of claim 18, wherein the plurality of workload sizes comprises each workload size between the workload size of 1 and the set workload size.

20. The apparatus of claim 18, wherein the at least one circuit is configured to perform the processing and storing in response to receipt of the at least one model to process data.
